(19) United States
(12) Patent Application Publication
(10) Pub. No.: US 2007/0255187 A1
(43) Pub. Date: Nov. 1, 2007

(54) VIBRATING THERAPY DEVICE

(76) Inventor: Alan P. Branch, Fair Lawn, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/627,576

(22) Filed: Jan. 26, 2007

Related U.S. Application Data
(60) Provisional application No. 60/794,922, filed on Apr. 26, 2006.

(51) Int. Cl. A61H 1/00

(52) U.S. Cl. 601/15

(57) ABSTRACT

A device for providing therapy to a user including vibration and temperature modulation. The device provides mobile temperature modulation capabilities, mobile vibration capabilities, or a combination of the two. The device provides advantages to a person or animal including the ability to utilize the device in a hands-free manner. The device may also provide, under certain circumstances, pain relief or healing therapy to a person or animal.

### CROSS REFERENCE TO RELATED APPLICATIONS

This application claims the benefit of provisional patent application 60/794,922 filed Apr. 26, 2006 which is hereby incorporated by reference herein.

### BACKGROUND OF THE INVENTION

The present invention relates to therapeutic devices used to treat injury and discomfort by using hot or cold therapy applied to an individual or animal with a vibrating apparatus to massage or otherwise therapeutically stimulate the target area.

The advantages of hot and cold therapy for humans and animals are well known in the medical community for the treatment of pain, swelling, and inflammation. Cold therapy is useful in reducing pain and swelling from maladies such as sprained muscles and arthritis while heat therapy is commonly used in the treatment of poor circulation, muscle pain, and abdominal cramps.

Massage has been used to heal injuries and relax patients for centuries. Vibration therapy, like massage therapy, helps to increase circulation to injured areas and stimulate bone growth, promoting healing and relieving stress for users. Many physical therapists utilize vibrating massagers in the treatment of patients.

Devices known in the art to provide hot and cold therapy suffer many drawbacks and fail to provide ease of use to a user. Typical known devices may be difficult to hold on to an affected area of a body. Known devices may also not provide any temperature modulation or control in a portable unit. Known devices also typically fail to provide adequate pain relief.

Devices known in the art to provide massage therapy are similarly inconvenient to use. Most vibrating massage devices must be held during use and are uncomfortable to constantly hold, especially for areas such as the lower back or shoulders. The devices may also be heavy and unwieldy to patients with diminished strength, such as the elderly. The devices are also typically small and thus may not cover much area at any one time. Vibrating massagers as known in the art are also not adapted to be used while the user is sleeping.

Many devices have been used to provide hot or cold therapy. Other devices have been used to provide vibration and massage therapy. But no one device has ever provided convenient cold and hot therapy along with a vibrator to provide all of the benefits of both therapies in one device. Thus, there is a need for a device which is capable of providing temperature modulation and vibration. There is also a need for a device which provides mobile temperature modulation capabilities, mobile vibration capabilities, and a combination of the two.

### SUMMARY OF THE INVENTION

The present invention is a device for providing vibration together with temperature modulation. The present invention also provides mobile temperature modulation capabilities, mobile vibration capabilities, or a combination of the two. The present invention provides advantages to a person or animal including the ability to utilize the device in a hands-free manner. The device may also provide, under certain circumstances, pain relief or healing therapy to a person or animal. The device may provide vibration to a person or animal or vibration together with temperature modulation.

An embodiment of the present invention may be designed as a garment, such as a wrap. In other embodiments, the device may also comprise a bandage, body support, series of straps, or other type of garment adapted to be applied to or surround a portion of a user's body.

The device may be contoured to fit a specific area on the user's body, such as the foot, ankle, knee, lower back, shoulder, elbow, wrist, or hand of a user. The device may also have openings or flexible portions adapted to allow for user mobility while the user is wearing the device.

The device may also include at least one temperature modulating component attached to the wrap or incorporated within the wrap. The temperature modulating component may take the form of a cold or heat pack. The temperature modulating component may also be provided in the form of a heating coil or other heating element. The device may position the temperature modulating component in close proximity to the user's skin. The temperature modulating component may be contained in pouches or adhered to the device in such a way as to make it easily removable. The temperature modulating component may provide soothing cold or heat therapy to a portion of the user's body.

In one embodiment, the temperature modulating element may be an infrared heat source. In another embodiment, the temperature modulating element may also be an ultraviolet heat source or a heat lamp filament as known in the art.

In one embodiment, the present invention may be a device with two or more temperature modulating elements adapted to emit different temperatures to different regions on a user's body.

The device may be adapted to provide control of the temperature modulating element. In one embodiment, the temperature modulating element may be a heating coil which may be adjusted to emit different levels of heat or preprogrammed to adjust temperature based on a variety of factors including time of day, length of application, severity of injury, etc. The heating coil may be controlled using a controller coupled to the device, such as, for example, a wired controller or a wireless controller. The controller may also be used to control any vibrating element coupled to the device. In another embodiment, the temperature modulating element may be a cold pack which is wrapped in at least one layer of insulation material. The cold pack may be wrapped in a plurality of layers of insulation material or other material in order to control the temperature emitted from the cold pack to the skin of a user. In another embodiment, the temperature modulating element may comprise a combination of a cold pack and heating element, such as a heating coil. In this embodiment, the heating coil may be placed near the cold pack or adjacent to the cold pack such that the control of the heating coil will diminish the temperature emitted from the cold pack and thus control the overall temperature emitted to the user.

The device may further include at least one vibrating element. The vibrating element may be coupled to the device using, for example, a pouch, straps, adhesive, hook and loop fasteners, snaps, or pressure. The vibrating element may be permanently coupled to the device. The vibrating element may be adjusted to provide different levels of massage therapy by, for example, adjusting the frequency or adjusting the power of the vibrator. In one embodiment, the vibrating element may have pre-programmed power settings such as “low,” “medium,” and “high.” The vibrating element may be controlled using a controller coupled to the device, such as, for example, a wired controller or a wireless controller.

In one embodiment, the vibrating element may be adapted to emit three adjustable forms of vibration: constant steady vibration which will emit one frequency and one power level throughout the use of the element; rolling wave vibration which will slowly change vibration frequency, power, or both from a low setting to a high setting and back again over timed intervals; and pulsing or throbbing vibration which will emit vibration of a given power or frequency at timed intervals.

In one embodiment, the device comprises at least two vibrating elements which may be set to different power levels or different frequencies to provide relief to different areas of a user's body.

In one embodiment, the present invention is a device that comprises at least one vibrating element and at least one temperature modulating element wherein either or both of the vibrating element and the temperature modulating element is powered by a mobile power source such as, for example, one or more batteries. The battery may be a conventional battery as known in the art or a rechargeable battery such as, for example, a laptop battery. The battery may be coupled to the device or adapted to be attached to another area of the user's body such as, for example, a belt. The battery may be removable and adapted to be connected to a power source such as, for example, a conventional wall outlet or automobile power socket for recharging. The battery may also be recharged using a power generating unit coupled to the device such as, for example, a hand actuated generator or a solar power generating device. Alternatively the device may be powered directly by a power generating unit.

In one embodiment, the present invention is a device that comprises at least one vibrating element and at least one temperature modulating element wherein either or both of the vibrating element and the temperature modulating element is powered by an A/C adapter. The A/C adapter may be coupled to a power source in an automobile, boat, train, or plane.

In another embodiment, the present invention may be powered by coupling the device to a computer, such as a personal computer. The device may be coupled using, for example, a USB cable.

A device according to the present invention may have include a processor or logic element which may be set to control the temperature or vibration of the device according to a pre-programmed regimen. The processor may control the frequency of vibration, the power of the vibration, or activating or deactivating of vibration, the activation or deactivation of the temperature modulation element, and the degree of power or the temperature to be emitted by the temperature modulating element. In one embodiment, pre-programmed therapeutic regimens may be downloaded to the processor from portable media such as, for example, USB drives, or from coupling to a computer using, for example, a USB cable or wireless connection. Pre-programmed therapeutic regimens may be downloaded to the processor from the Internet.

In one embodiment, the present invention is a device comprising a flexible carrier having a first coupling element and a second coupling element which corresponds to the first coupling element; a third coupling element coupled to the flexible carrier; an enclosure containing a temperature retaining compound coupled to the third coupling element; a fourth coupling element coupled to the flexible carrier; and a vibrator adapted for coupling to the fourth coupling element.

In another embodiment, the present invention comprises a device comprising a flexible carrier having a first coupling element and a second coupling element, wherein the first coupling element is coupled to the second coupling element; and at least one vibrator coupled to the flexible carrier.

In another embodiment, the present invention comprises a method of providing therapy to a user comprising placing a support against the user, coupling a vibrator to the support, coupling a thermal element to the support, and activating the vibrator.

In another embodiment, the present invention comprises a vibrating element that is coupled to an adhesive or a hook and loop fastener system which allows the user to attach the vibrating element directly to a garment, bandage, temperature emitting apparatus, or wrap that the user is wearing. The user may also be able to remove the vibrating element and reattach it to other garments as necessary for pain relief.

### BRIEF DESCRIPTION OF THE FIGURES

FIG. 1 depicts one embodiment of a device according to the present invention.

FIG. 2 depicts the device shown in FIG. 1 as attached to a user.

FIG. 3 is an alternate view of the device shown in FIG. 2.

FIG. 4 depicts another embodiment of a device according to the present invention adapted to surround a user's ankle.

FIG. 5 depicts another embodiment of a device according to the present invention adapted to be applied to a user's shoulder area.

FIG. 6 depicts another embodiment of a device according to the present invention adapted to surround a user's abdomen.

FIGS. 7A and 7B depict another embodiment of a device according to the present invention adapted to surround a user's hip area.

FIGS. 8A and 8B depict another embodiment of a device according to the present invention adapted to surround a user's hips and abdomen.

FIG. 9 depicts another embodiment of a device according to the present invention adapted to be fitted to a user's hand.

### DETAILED DESCRIPTION

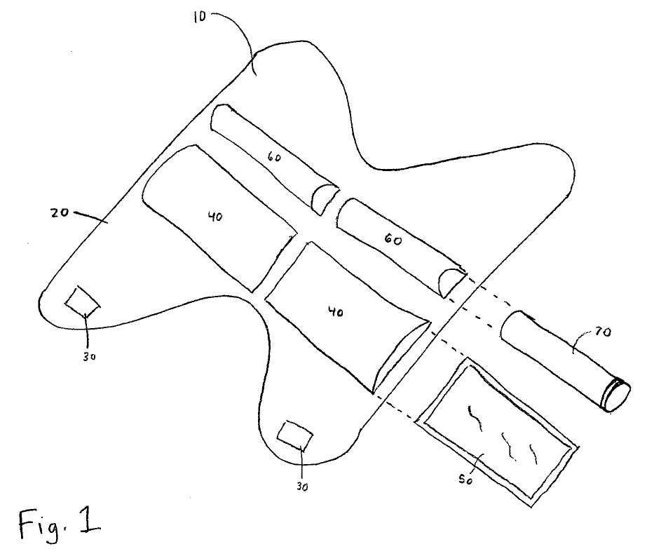

A preferred embodiment of the present invention will now be described with reference to the attached figures. In FIG. 1, a device 10 according to the present invention preferably comprises a wrap 20 with fasteners 30. The device preferably contains a plurality of openings or pouches 40 adapted to receive cold or heat packs 50. The device 10 also has a narrow pouch 60 adapted to receive a vibrating apparatus 70. When the device is to be used, it is placed in position against the user's skin, and cold or heat packs are inserted into the device depending on the preference of the user. A vibrating apparatus is then inserted into the device and activated so that the device will provide the user with a vibrating massage at the same time as the cold or heat is applied to the area.

Although the device depicted in the figures contains a plurality of pouches, one skilled in the art would recognize that cold or heat packs as well as vibrating apparatuses may be affixed to the device in a plurality of ways, such as with straps, adhesive, hook and loop fasteners, snaps, or pressure.

The device preferably has openings, pockets, pouches, or couplings to contain or affix one or more cold or heat packs so that when the packs are no longer the proper temperature to provide the user with the desired therapy, they may be removed from the device and replaced with replacement cold or heat packs without having to remove the device from the user. This will be particularly useful in instances of moderate to severe muscle sprains when the device comprises a brace adapted to apply pressure to an injured area and hold it in place.

In embodiments where the device may accommodate more than one cold or heat pack, the user may choose to add both cold and heat packs to different areas of the device. For example, in an embodiment where the device surrounds the shoulder, the user may employ a heat pack on the front of the device and an ice pack on the back of the device to ease a sore shoulder and a stiff neck with different temperature therapies.

Similarly, the vibrating apparatus is adapted to be easily added and removed from a pocket or pouch in the device. This allows the user to remove the vibrator when it is no longer desired such as when it requires recharging for a new battery or power pack or to wash the device.

In one embodiment, the device may be used without any cold or heat packs to provide only convenient, hands-free vibrating massage therapy.

In embodiments where multiple vibrators are used, the pouches for the vibrators are preferably located around a joint or affected area in such a way as to maximize vibration of the area without the multiple vibrators conflicting in any way. For example, if the device is a wrap surrounding a knee, a vibrator will likely be included on either side of the knee joint and one may also be included under the kneecap. The various vibrators emit vibrations from multiple directions in order to be extremely effective and not emit conflicting vibrations.

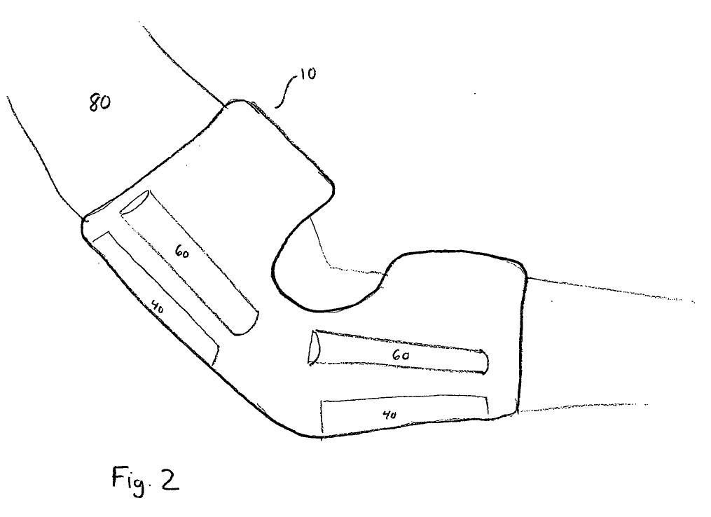

FIG. 2 depicts a device according to the present invention as affixed to the elbow region of a user. The arm 80 of a user is shown with the device 10 affixed thereto. The device 10 is preferably soft and flexible so that it is comfortable for the user to wear. The narrow pouches 60 contain vibrators for massaging the area, while the pouches 40 contain cold or heat packs to provide temperature therapy to the desired area.

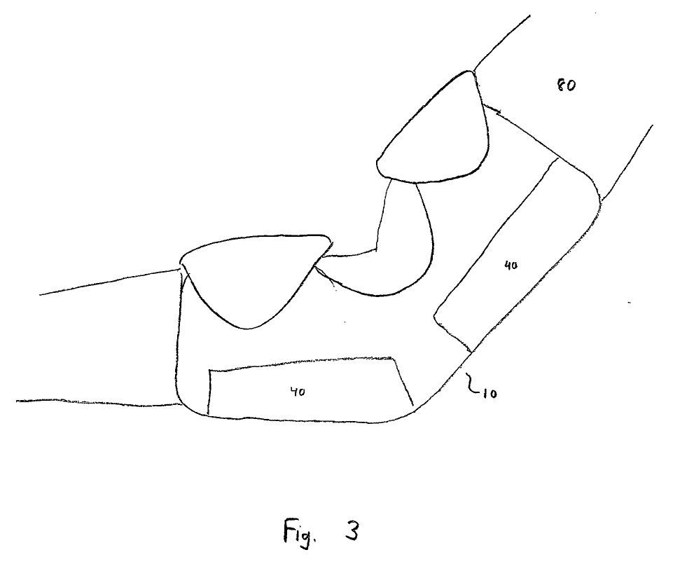

FIG. 3 depicts the opposite side of the device shown in FIG. 2. The device 10 is attached to the arm 80 of a user and the pouches 40 contain cold or heat packs to provide temperature therapy to the desired area.

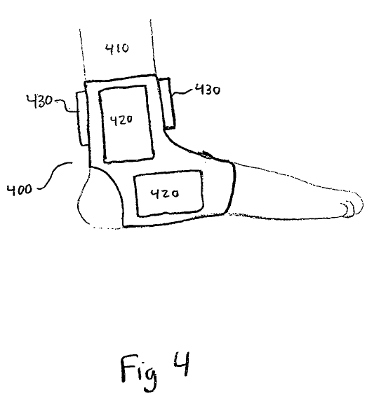

FIG. 4 depicts an alternate embodiment of a device according to the present invention. The device 400 is adapted to surround the ankle region of a user 410. This device may be particularly useful in the case of ankle sprains. The device 410 has pockets 420 which are adapted to receive cold or heat packs to provide the user with temperature therapy in the desired area. The device 400 preferably also has two vibrators 430 attached to the device 400 to provide massage therapy to the desired area. As shown in this example, the wrap portion of the device may be specially adapted to surround a specific area of a body.

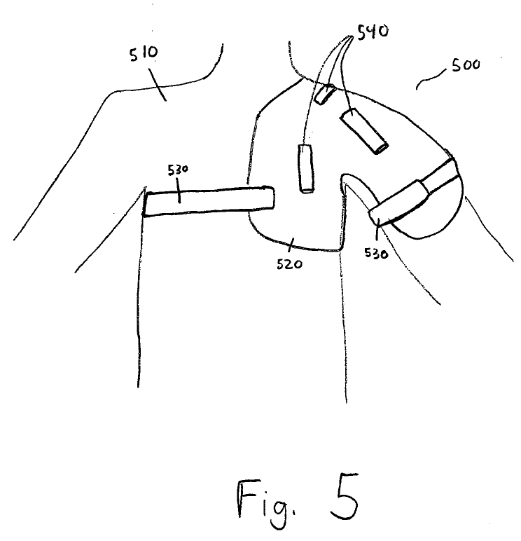

FIG. 5 depicts another embodiment of the present invention in the form of a device 500 adapted to cover the shoulder area of a user 510. The device 500 comprises a large gel pack 520 which is held on the user with straps 530. The straps 530 are preferably affixed to the gel pack using a hook and loop fastener system such as Velcro™, but a number of methods of attachment may be used. The gel pack preferably has a plurality of pockets 540 used to receive vibrators which provide massage therapy to the area. The pockets 540 are preferably located in areas which provide the most relief to the user based on their particular needs, such as a location on the top of the shoulder to relieve bursitis pain. The gel pack 520 may be placed in the freezer prior to wearing so that the gel pack retains a cold temperature and provides the user with cold therapy for an extended period. If the user desires heat therapy, the gel pack may be placed in a microwave oven for a given period of time to heat the gel pack, which will retain heat and provide the user with heat therapy. Thus, the device depicted in FIG. 5 conveniently provides either heat therapy or cold therapy to a user along with vibrating massage therapy.

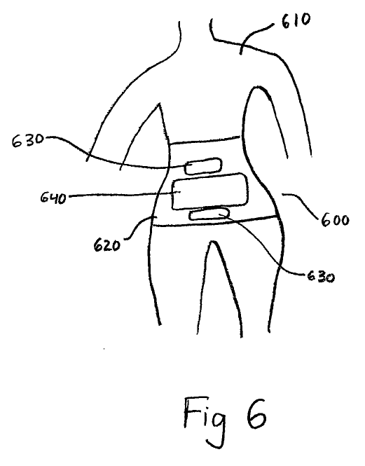

FIG. 6 depicts another embodiment of the present invention adapted to surround the abdomen area of the user. The device 600 is preferably made of a soft, flexible wrap 620 made of a material such as neoprene and applied directly to the abdomen of a user 610. The device 600 may be flexible enough to pull on to the user or it may simply wrap around the user and overlap with an area of hook and look fasteners to keep the device 600 in place. The device 600 further comprises at least one vibrator 630 and at least one cold or heat pack 640. The vibrator 630 and the cold or heat pack 640 may be position on the inside of the device 600 such that they rest directly against the skin of the user when the device 600 is attached to the user.

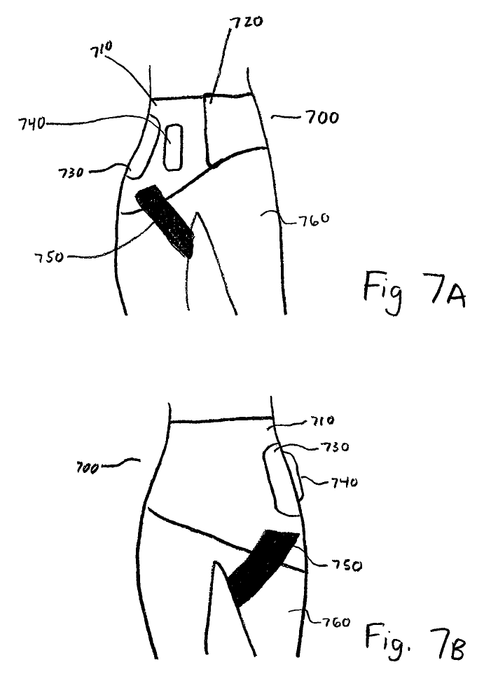

FIGS. 7A and 7B depict another embodiment of the invention adapted to be applied to the hip of the user. FIG. 7A depicts the front of the device as attached to the front of a user's body and FIG. 7B depicts the rear of the device as attached to the rear of a user's body. In this embodiment, the device 700 surrounds the hip region of the user 760. The device 700 preferably comprises a flexible wrap 710 which is wrapped around the user and secured with an overlapping portion 720 that may have a hook and loop fastener system for holding the device 700 in place. The device 700 further comprises at least one cold or heat pack 730 and at least one vibrator 740. The device may also comprise a strap 750 to help hold the device 700 in place. The strap 750 is preferably of a flexible material such as elastic and may be affixed to the device with stitching on one side and a hook and look fastener or adhesive on the opposite side. This embodiment of the device is especially useful for users suffering from hip pain due to hip surgery or arthritis. The cold or heat packs 730 may be adjusted to be over the most painful area on the user's body. The vibrator 740 or vibrators may also be positioned to provide massage therapy to the most painful areas of a user.

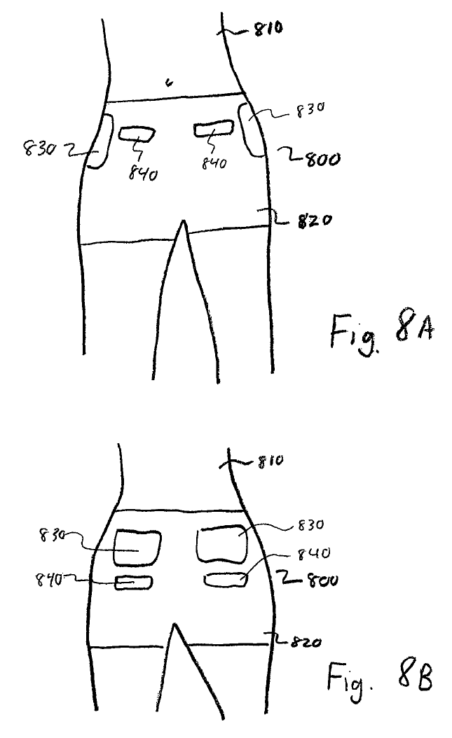

FIGS. 8A and 8B depict an embodiment of the invention adapted to surround the hip and waist area of a user. FIG. 8A depicts the front of a device 800 as worn by a user 810. FIG. 8B depicts the rear of a device 800. The device 800 preferably comprises a pair of shorts 820 such as boxer briefs or any other type of undergarment known in the art. The shorts 820 are preferably made of a soft, flexible material such as cotton, polyester, spandex, or a combination thereof. The shorts 820 preferably have at least one cold or heat pack 830 arranged in the joint areas which typically provide discomfort to users. In one embodiment, the heat and cold packs may be relocated by the user to place them directly over painful areas to maximize pain relief. The device 800 preferably further comprises at least one vibrator 840 used to massage painful areas on a user 810.

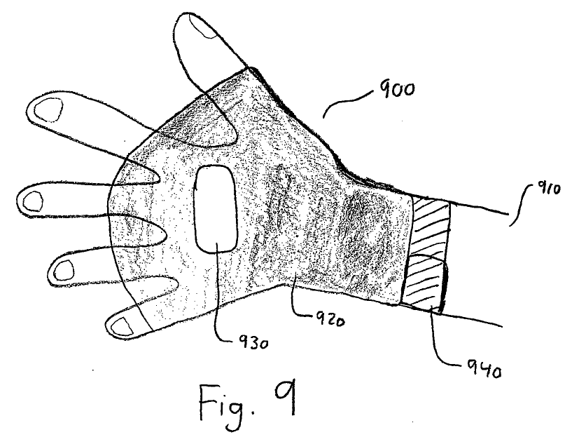

FIG. 9 depicts an embodiment of the invention as applied to the hand of a user. The device 900 may take the form of a full or partial glove which surrounds all or part of a user 910's hand. The device 900 is preferably made of a flexible material 920 that stretches to fit over the hands of users with various different hand sizes. The device 900 further comprises at least one removable vibrator 930 adapted to provide massage therapy to the user. The device may further comprise a strap 940 adapted to hold the device 900 firmly to the user in order to maximize effectiveness of the massage therapy. This embodiment of the invention is particularly useful to users who suffer from arthritis in the hands. Although not pictured, the device 900 may further comprise at least one cold or heat pack to provide temperature therapy and further pain relief to the user.

Although not all embodiments of the invention have pouches or pockets, one advantage of the pouches adapted to receive cold or heat packs is that various different cold or heat packs may be used with the present invention. This is advantageous to the user in that the user may utilize the device with cold or heat packs that he or she already owns. Reusable cold or heat packs as known in the art may be inserted into the pouches as well as chemically-activated ice or heat packs. In some embodiments, a device according to the present invention includes cold or heat packs that are battery-operated using standard batteries, camera batteries, or laptop batteries as known in the art. The device may also be adapted to be plugged into a standard A/C socket in order to maintain a desired temperature for long periods of time. In another embodiment, a user may simply add bags of ice or hot water to the pouches of the device.

The device is similarly flexible with regards to the vibrator to be used. The vibrator may be battery-operated or adapted to be plugged into a standard A/C socket. The vibrator may be adjustable so that the user may adjust the frequency of the vibrations and may allow a user to vary the frequency from 10 Hz to 110 Hz. The device may accommodate a plurality of vibrators that the user may purchase from other sources.

The vibrator may be adapted to emit a pattern of vibration such as a wave vibration which will emit vibration which increases and decreases power and frequency of vibrations over a predetermined time. The vibrator may also be adapted to emit pulses of vibration of a given power and frequency at timed intervals.

The device may also include a single pouch or a plurality of pouches for receiving one or more vibrators. Where a plurality of vibrators are used, the vibrators may all be coupled so that they can be set to the same frequency and adjusted simultaneously. Alternatively, one or more of the vibrators may be set in a different frequency or independently adjustable. A plurality of vibrators may be advantageous where the area to be massaged is large or where a more intense massage is desired.

In one embodiment, the device comprises a single neoprene wrap with Velcro™ closures, numerous pockets for cold or heat packs, numerous pockets for vibrators, and a central control unit so that the user can adjust the temperature and vibration of the device. The central control device is connected to the various heating/cooling elements as well as the various vibrators in order to control all aspects of the device. In one embodiment, the central control device has a plurality of levers or knobs to control the intensity of vibration. In a further embodiment, one central controller on the device is adapted to control multiple devices located on different areas of a person. For example, the user may be wearing a knee brace and an ankle brace, with the central controller on the knee brace. The central controller will be able to control the temperature and vibration of both the knee brace and the ankle brace.

In another embodiment, the device comprises a wrap adapted to fit a certain part of the body, such as a shoulder wrap, with a plurality of pockets for receiving cold or heat packs and two vibrators. Either the temperature or the vibration of the shoulder wrap, or both, can be controlled using a remote control. This provides ease of control with minimal movement which is especially useful in the case of severely injured users.

In another embodiment, the present invention is a device comprising a plurality of cold or heat packs that are permanently affixed to the device as well as a plurality of vibrators that are permanently affixed to the device. The device preferably has a central controller that controls the cold or heat packs as well as the vibrators. This embodiment of the device is convenient in that the user need not add or remove any vibrators or heat packs; the single device contains all of the necessary tools to provide temperature and massage therapy as soon as it is activated.

A device according to the present invention may also be powered by a rechargeable battery, such as a laptop battery. Such a device would preferably be connected to an A/C outlet as a power source when convenient for the user but may switch to battery power when the A/C power source is disconnected. For example, if a user is in a hospital bed and has the device on his knee to help recover from surgery, the device may be connected to an A/C power supply in the hospital room. If the user is moved to a different room, the device may be unplugged and still function normally utilizing battery power until the device can be reconnected to an A/C outlet.

The bandage or wrap portion of the device is preferably constructed from neoprene material but one skilled in the art would recognize that a plurality of materials may be used, such as cotton, wool, spandex, polyester, other synthetic or natural fibers, or any combination thereof.

Although a wrap is described above, one skilled in the art would recognize that the present invention may also be a bandage, body support, or other type of garment with pouches to receive cold or heat packs and vibrating apparatuses. In one embodiment, the present invention is a wrap with straps, such as straps having hook and loop fastener attachment means, for attachment of cold or heat packs on the side facing the user's body or away from the user's body.

In one embodiment, the invention comprises a wrap with a side adapted to contact a user's skin and an opposite side adapted to receive cold or heat packs. The opposite side is preferably covered in a series of loops typically used in a hook and loop fastener system, such as Velcro™. This embodiment preferably further includes at least one pouch for holding cold or heat packs and at least one pouch for holding a vibrator. The pouches are preferably separate from the wrap but are coated in a series of hooks so that they may be easily attached to any location on the opposite side of the wrap. In this embodiment, a user may secure the wrap to an area of their body, place cold or heat packs in at least one pouch, place a vibrator in at least one pouch, and then attach the pouches to the wrap in the desired location. The wrap may have colored areas to suggest to the user where heat or vibration therapy would be most effective, providing a recommendation as to where the user should locate the pouches.

In some embodiments, a device according to the present invention may have pockets or areas of gel or liquid which may help to transmit vibration from one or more vibrators to the user.

The present invention may also take the form of an adhesive patch which becomes hot or cold when activated but has an opening or other means for attaching a vibrating apparatus thereto in order to provide vibrating massage as well as hot/cold therapy at the same time or different times.

1. A device comprising:
a flexible carrier having a first coupling element and a second coupling element, wherein the first coupling element corresponds to the second coupling element;
a third coupling element coupled to the flexible carrier;
an enclosure containing a temperature retaining compound coupled to the third coupling element;
a fourth coupling element coupled to the flexible carrier; and
a vibrator adapted for coupling to the fourth coupling element.

2. The device of claim 1 wherein the vibrator is permanently coupled to the fourth coupling element.

3. The device of claim 1 wherein the vibrator is powered by a battery pack.

4. The device of claim 3 wherein the battery pack is coupled to the flexible carrier.

5. The device of claim 4 wherein the battery pack is rechargeable.

6. The device of claim 1 wherein the first coupling element and the second coupling element are hook and loop fasteners.

7. The device of claim 6 wherein the third coupling element is a pouch.

8. The device of claim 1 wherein the fourth coupling element is a pouch.

9. The device of claim 1 wherein the enclosure containing a temperature retaining compound is an ice pack.

10. The device of claim 1 wherein the enclosure containing a temperature retaining compound is a heat pack.

11. The device of claim 1 wherein the first coupling element is coupled to the second coupling element with an adhesive.

12. The device of claim 1 wherein the first coupling element is coupled to the second coupling element with a snap closure.

13. A device comprising:
a flexible carrier having a first coupling element and a second coupling element, wherein the first coupling element is coupled to the second coupling element; and
at least one vibrator coupled to the flexible carrier.

14. The device of claim 13 further comprising
at least one temperature retaining element coupled to the flexible carrier.

15. The device of claim 14 wherein the at least one temperature retaining element is permanently attached to the flexible carrier.

16. The device of claim 14 wherein the at least one temperature retaining element is an ice pack.

17. The device of claim 14 wherein the at least one temperature retaining element is a heat pack.

18. The device of claim 13 wherein the at least one vibrator is permanently attached to the flexible carrier.

19. The device of claim 13 wherein the first coupling element is coupled to the second coupling element with an adhesive.

20. The device of claim 13 wherein the first coupling element is coupled to the second coupling element with hook and loop fasteners.

21. The device of claim 13 wherein the at least one vibrator is powered by a battery pack.

22. The device of claim 21 wherein the battery pack is coupled to the flexible carrier.

23. The device of claim 22 wherein the battery pack is rechargeable.

24. The device of claim 13 wherein the at least one vibrator is powered by an A/C adapter.

25. The device of claim 14 wherein the at least one temperature retaining element comprises a heat pack and an ice pack.

26. The device of claim 13 wherein the at least one vibrator has an adjustable frequency.

27. The device of claim 13 wherein the at least one vibrator has an adjustable power.

28. The device of claim 14 wherein the at least one temperature retaining element is powered by a battery pack.

29. The device of claim 28 wherein the at least one vibrator is powered by the battery pack.

30. The device of claim 14 wherein the at least one temperature retaining element is powered by an A/C adapter.

31. The device of claim 30 wherein the at least one vibrator is powered by the A/C adapter.

32. The device of claim 14 wherein the temperature of the temperature retaining element is adjustable.

33. The device of claim 32 wherein the temperature of the temperature retaining element is adjustable using at least one insulating layer.

34. The device of claim 32 wherein the temperature of the temperature retaining element is adjusted using a wireless controller.

35. The device of claim 32 wherein the temperature of the temperature retaining element is adjustable using an adjustable heating coil.

36. The device of claim 32 wherein the heating coil is located adjacent to a second temperature retaining element.

37. The device of claim 14 wherein the temperature retaining element has at least two regions which may be adjusted to retain different temperatures.

38. The device of claim 37 wherein the temperature retaining element is powered by a battery pack.

39. The device of claim 37 wherein the temperature retaining element is controlled by a central controller.

40. The device of claim 39 wherein the at least one vibrator is controlled by the central controller.

41. The device of claim 40 wherein the central controller is coupled to the flexible carrier.

42. The device of claim 41 wherein the central controller is powered by a battery pack.

43. The device of claim 42 wherein the at least one vibrator and the at least one temperature retaining element are powered by the battery pack.

44. A method of providing therapy to a user comprising:
placing a support against the user,
coupling a vibrator to the support,
coupling a thermal element to the support, and
activating the vibrator.

45. The method of claim 44 further comprising:
coupling the support to the user.
